(19) United States
(12) Patent Application Publication
(10) Pub. No.: US 2026/0021393 A1
(43) Pub. Date: Jan. 22, 2026

(54) GAME DISPLAY CONTROL METHOD AND APPARATUS, AND ELECTRONIC DEVICE

(71) Applicant: NETEASE (HANGZHOU) NETWORK CO., LTD., Hangzhou, Zhejiang (CN)

(72) Inventor: Jiancong LIU, Fuzhou, Fujian (CN)

(73) Assignee: NETEASE (HANGZHOU) NETWORK CO., LTD., Hangzhou, Zhejiang (CN)

(21) Appl. No.: 18/998,539

(22) PCT Filed: Apr. 27, 2023
(86) PCT No.: PCT/CN2023/091359

§ 371 Date: Jan. 27, 2025

(30) Foreign Application Priority Data
Aug. 5, 2022 (CN) 202210935881.0

(51) Int. Cl. A63F 13/537

(52) U.S. Cl. CPC A63F 13/537

(57) ABSTRACT

A game display control method, comprising: in response to a trigger operation for a first scene plot in a first scene picture, determining an expedition route for a target team to march to the first scene plot; displaying on the first scene picture an expedition information control, the expedition information control being used for displaying expedition information about the target team marching to the first scene plot; and in response to an obstacle position present on the expedition route, displaying in the expedition information control obstacle prompt information for the obstacle position, the obstacle prompt information comprising position information of at least one obstacle position on the expedition route. Also provided are a game display control apparatus, an electronic device, and a readable storage medium.

### CROSS REFERENCE TO RELATED APPLICATIONS

The present disclosure is a U.S. National Stage of International Application No. PCT/CN2023/091359, filed on Apr. 27, 2023, which claims the priority of the Chinese patent application with an application number of 202210935881.0, filed on Aug. 5, 2022, and titled by “Game display control method and apparatus, and electronic device”, the entire contents of both of which are incorporated herein by reference for all purposes.

### TECHNICAL FIELD

The present disclosure relates to the technical field of game, and in particular, to a display control method and apparatus for a game, and an electronic device.

### BACKGROUND

In a simulation game (strategy game, SLG), marching is a fundamental game behavior. Before marching, a player needs to complete an expedition operation. Specifically, after the player selects a target team to be dispatched on the expedition and the expedition destination, the interface may jump to a map system, which may show the expedition route for the target team to march to the expedition destination, and obstacle points on the expedition route.

### SUMMARY

According to an aspect of the present disclosure, a display control method for a game is provided, where a graphical user interface is provided by a terminal device, the graphical user interface includes a first scene screen of a target game scene, and the target game scene includes a plurality of scene plots; where the method includes: in response to a trigger operation on a first scene plot in the first scene screen, determining an expedition route for a target team to march to the first scene plot; displaying an expedition information control on the first scene screen, where the expedition information control is used to display expedition information of the target team marching to the first scene plot; and in response to an obstacle position existing on the expedition route, displaying obstacle prompt information for the obstacle position in the expedition information control; where the obstacle prompt information includes: position information of at least one obstacle position on the expedition route.

According to an aspect of the present disclosure, a display control apparatus for a game is provided, where a graphical user interface is provided by a terminal device, the graphical user interface includes a first scene screen of a target game scene, and the target game scene includes a plurality of scene plots; where the apparatus includes: a determination module, configured to, in response to a trigger operation on a first scene plot in the first scene screen, determine an expedition route for a target team to march to the first scene plot; a control display module, configured to display an expedition information control on the first scene screen, where the expedition information control is used to display expedition information of the target team marching to the first scene plot; and an information display module, configured to, in response to an obstacle position existing on the expedition route, display obstacle prompt information for the obstacle position in the expedition information control; where the obstacle prompt information includes: position information of at least one obstacle position on the expedition route.

According to an aspect of the present disclosure, an electronic device is provided, including a processor and a memory, where the memory stores machine-executable instructions that can be executed by the processor, and the processor executes the machine-executable instructions to implement the above display control method for the game.

According to an aspect of the present disclosure, a machine-readable storage medium is provided, where the machine-readable storage medium stores machine-executable instructions, and when the machine-executable instructions are called and executed by a processor, the machine-executable instructions prompt the processor to implement the above display control method for the game. The embodiments of the present disclosure bring the following beneficial effects.

### BRIEF DESCRIPTION OF THE DRAWINGS

FIG. 1 is a flow chart of a display control method for a game provided by an embodiment of the present disclosure.

FIG. 2 is a schematic diagram of an expedition information control provided by an embodiment of the present disclosure.

FIG. 3 is a schematic diagram of displaying a scene map in the expedition information control provided by an embodiment of the present disclosure.

FIG. 4 is a schematic diagram of displaying a scene screen in the expedition information control provided by an embodiment of the present disclosure.

FIG. 5 is a schematic diagram of a second scene screen and a quick coordinate bar provided by an embodiment of the present disclosure.

FIG. 6 is a schematic diagram of displaying obstacle prompt information via a separate window provided by an embodiment of the present disclosure.

FIG. 7 is a schematic structural diagram of a display control apparatus for a game provided by an embodiment of the present disclosure.

FIG. 8 is a schematic diagram of an electronic device provided by an embodiment of the present disclosure.

### DETAILED DESCRIPTION

In order to make the purposes, technical solutions and advantages of the embodiments of the present disclosure clearer, the technical solutions of the present disclosure will be clearly and thoroughly described below with reference to the accompanying drawings. Obviously, the described embodiments are a part of the embodiments of the present disclosure, rather than all of the embodiments. Based on the embodiments in the present disclosure, all other embodiments obtained by those skilled in the art without making creative efforts fall within the scope of protection of the present disclosure.

In SLG games, an expedition operation is required before marching. If the marching route of the expedition team currently selected by the player is blocked, the player needs to be given certain prompts and solutions so that the player can successfully complete the marching. In the related art, after the player selects the expedition target and the expedition team in the game scene, the game interface may jump to the map system, in which the expedition route and the obstacle positions on the expedition route are displayed. In this manner, during the expedition operation process, it is necessary to jump to the map system, and the player needs to identify the corresponding relationship between the icons on the map and the buildings in the game scene, which is accompanied with a certain recognition and cognition cost, and it is particularly unfriendly to novice players, which affects the gaming experience of the player.

That is, since the icons in the map are displayed differently from the corresponding buildings in the game scene, the player needs to know the corresponding relationship between the two. For a novice player, there is a high recognition and cognition cost, which affects the gaming experience of the player, increases the running time of the game session on the terminal device, and consumes power of the terminal device.

Based on the above, the embodiments of the present disclosure provide a display control method and apparatus for a game, and an electronic device. This technology can be applied to SLG games or other games that have the requirements for displaying maps and routes.

The display control method for the game in one of the embodiments of the present disclosure may be run on a local terminal device or a server. When the display control method for the game is run on the server, the display control method for the game may be implemented and executed based on a cloud interaction system, where the cloud interaction system includes a server and a client device.

In an implementation, various cloud applications, such as cloud games, may be run under the cloud interaction system. Taking cloud games as an example, cloud games refer to a game mode based on cloud computing. In the operation mode of cloud games, the operating body of the game program and the main body for presenting the game screen are separated. The storage and operation of the display control method for the game are completed on the cloud game server, and the client device is used for receiving and sending data as well as presenting the game screen. For example, the client device may be a display device close to the user side with a data transmission function, such as a mobile terminal, a TV, a computer, a handheld computer, etc., while the cloud game server in the cloud is used for information processing. When playing the game, the player operates the client device to send an operation instruction to the cloud game server, the cloud game server runs the game according to the operation instruction, encodes and compresses data like the game screen, and returns it to the client device through the network. Finally, the client device decodes and outputs the game screen.

In an implementation, taking a game as an example, a local terminal device stores a game program and is used for presenting a game screen. The local terminal device is used to interact with the player via a graphical user interface, that is, the game program is downloaded and installed by an electronic device and run conventionally. The local terminal device may provide the graphical user interface to the player in various ways, for example, the graphical user interface may be rendered and displayed on a display screen of the terminal, or provided to the player through a holographic projection. By way of example, the local terminal device may include a display screen and a processor, the display screen is used to present the graphical user interface, the graphical user interface includes a game screen, and the processor is used to run the game, generate the graphical user interface, and control the display of the graphical user interface on the display screen.

In a possible implementation, an embodiment of the present disclosure provides a display control method for a game, which provides a graphical user interface through a terminal device, where the terminal device may be the local terminal device mentioned above, or may be the client device in the cloud interaction system mentioned above.

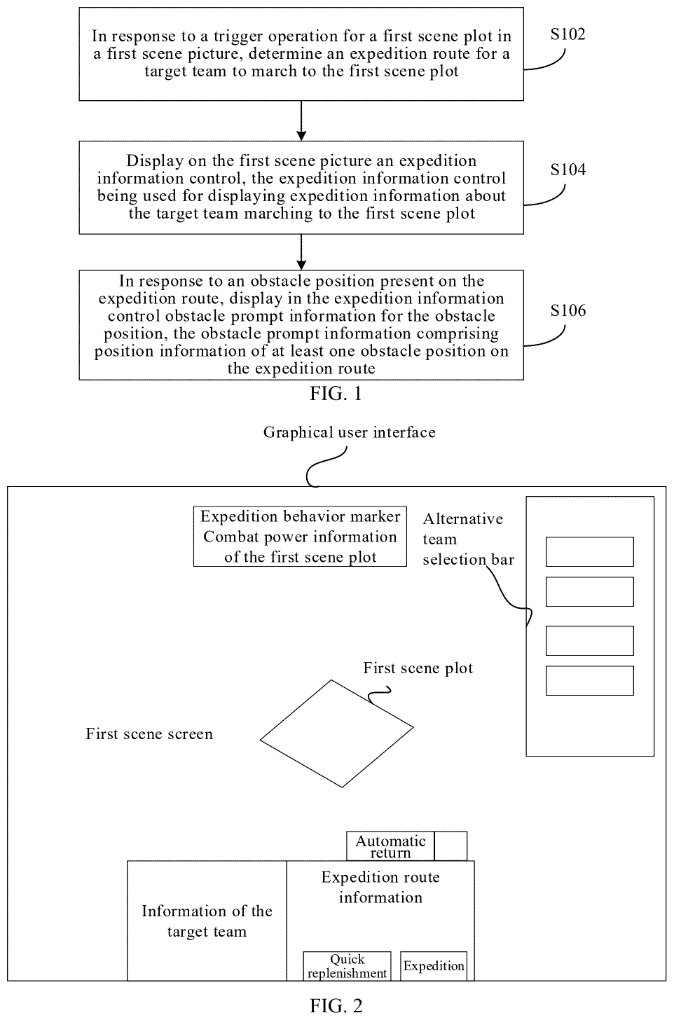

To facilitate the understanding of this embodiment, a detailed introduction will be first given to a display control method for a game disclosed in the embodiments of the present disclosure. As shown in FIG. 1, the display control method for the game provides a graphical user interface through a terminal device. The terminal device may be the local terminal device described above, or the client device described above. The graphical user interface includes a first scene screen of the target game scene, and the target game scene includes a plurality of scene plots. The target game scene is usually divided into a plurality of scene plots, and the scene plots may be rectangular, hexagonal, or in other shapes. The player may control the team to occupy the plots, build buildings on the plots, and perform other operations. A virtual camera shoots in the target game scene to obtain the above-mentioned first scene screen. The display control method for the game includes the following steps.

In step S102, in response to a trigger operation on a first scene plot in the first scene screen, an expedition route for a target team to march to the first scene plot is determined.

The above trigger operation may be a click operation, a long press operation, a double click operation, etc. The trigger operation is specifically used to trigger the expedition behavior for the first scene plot. For example, if the player conducts an expedition towards the above first scene plot, the above trigger operation is performed on the first scene plot. Then, the game system determines the above expedition route according to the position of the first scene plot and the position of the expedition team owned by the current player account.

If there is only one expedition team in the current player account, the position of the expedition team is used as the starting point of the route, and the location of the first scene plot is used as the end point of the route, to generate the above-mentioned expedition route. If there are a plurality of expedition teams in the current player account, and each expedition team has a different location, one of the expedition teams may be used as a default selected target team, and the location of the target team is used as the starting point of the route, and the location of the first scene plot is used as the end point of the route, to generate the above-mentioned expedition route. A selection control of each expedition team may also be displayed in the graphical user interface, and when the selected target team is changed, the expedition route also changes accordingly. Usually, after the target team is determined, the game system automatically generates the expedition route. The game system may generate only one expedition route, or it may generate a plurality of expedition routes for the player to choose.

In step S104, an expedition information control is displayed on the first scene screen, where the expedition information control is used for displaying expedition information of the target team marching to the first scene plot.

Usually, the display level of the expedition information control is higher than that of the first scene screen. In order to minimize obscuring the first scene screen, the expedition information control may be displayed at an edge position of the graphical user interface, for example, at the bottom, left, right, top, etc. The expedition information in the expedition information control may include the plot information of the first scene plot, the information of the target team, the information of the expedition route, etc. In a specific implementation, the expedition information may include an expedition behavior marker, combat power information of the first scene plot, team details of the target team, information of the alternative teams, time consumed for the expedition, time when the target team arrives at the first scene plot, a resource spent on the expedition, a selection control for whether to return automatically, etc.

Taking FIG. 2 as an example, the expedition information control is divided into a plurality of sub-controls, which are respectively displayed at the top, bottom and right side of the graphical user interface. The alternative teams available for the expedition are displayed in the alternative team selection bar. When the player selects another alternative team, the target team changes, and at this moment, the information of the target team will also change accordingly. The expedition route information is also provided with operation controls, such as a quick replenishment control and an expedition control. When the player clicks the expedition control, the expedition behavior starts according to the expedition information set by the current player.

In step S106, in response to an obstacle position existing on the expedition route, obstacle prompt information for the obstacle position is displayed in the expedition information control; where the obstacle prompt information includes: position information of at least one obstacle position on the expedition route.

If there is an obstacle position on the expedition route, the expedition towards the first scene plot cannot be carried out directly based on the current target team. It is usually necessary to replace the current target team with another team or capture the obstacle position. In this case, the player needs to check the relevant information of the obstacle position. In the related art, the graphical user interface usually jumps to the map, and displays the expedition route and the marker of the obstacle position on the map. Then, when the player triggers the obstacle position, it may jump again to the target game scenario, and display, in the scene screen, the plot where the obstacle position is located. This way of viewing the obstacle position requires a plurality of jumps, which is cumbersome.

In this embodiment, the obstacle prompt information of the obstacle position is directly displayed in the expedition information control, and the obstacle prompt information may be displayed in one sub-control in the expedition information control. For example, one sub-control is generated on the left side of the graphical user interface, and the obstacle prompt information is displayed in this sub-control. For another example, the obstacle prompt information is displayed in the sub-control that displays the expedition route information. In this case, since there is an obstacle position on the current expedition route, the expedition behavior cannot be directly carried out, the expedition route information is no longer displayed in this sub-control.

The obstacle prompt information may be in the form of a small map, in which the obstacle position is displayed. The obstacle prompt information may also be in the form of a scene, in which the plot corresponding to the obstacle position is displayed. The obstacle prompt information may also be in the form of text, through which the position information of the obstacle position, the affiliated camp, the number of obstacle positions on the expedition route, etc. are described. In this embodiment, the obstacle prompt information of the obstacle position is directly displayed through the expedition information control, and there is no need for the interface to jump to the map system. The player can learn about the relevant information of the obstacle position in the expedition information control.

In the above display control method for the game, a graphical user interface is provided by a terminal device, where the graphical user interface includes a first scene screen of a target game scene, and the target game scene includes a plurality of scene plots. In response to a trigger operation on a first scene plot in the first scene screen, an expedition route for a target team to march to the first scene plot is determined. An expedition information control is displayed on the first scene screen, where the expedition information control is used for displaying expedition information of the target team marching to the first scene plot. In response to an obstacle position existing on the expedition route, obstacle prompt information for the obstacle position is displayed in the expedition information control, where the obstacle prompt information includes: position information of at least one obstacle position on the expedition route. In this manner, when the player is performing the expedition operation, if there is an obstacle position on the expedition route, the obstacle prompt information can be displayed in the expedition information control, so that the player can learn about the situation of the obstacle position. It is not necessary to jump to the map system to display the information of the obstacle position, and it does not need the cost of recognition and cognition for comparing and checking between the scene and the map, thereby improving the gaming experience of the player.

The following embodiments continue to describe the specific display manners of the obstacle prompt information.

In one manner, in response to the obstacle position existing on the expedition route, at least a portion of a scene map of the target game scene is displayed in the expedition information control; where the at least a portion of the scene map includes a position marker corresponding to the obstacle position.

In this manner, the first scene screen including the first scene plot is still displayed on the graphical user interface, and at the same time, the scene map is displayed in the expedition information control, and the scene map includes the position marker corresponding to the obstacle position. If the obstacle position is a plot, the position marker of the plot where the obstacle position is located is displayed in the scene map. The position marker may display the obstacle position in a specific display format, or indicate the obstacle position in a specific shape, such as an arrow. This manner reduces the running time of the game session of the terminal device and saves the power consumption of the terminal device.

In another manner, based on the scene map, at least a portion of the expedition route is displayed in the at least a portion of the scene map; where the at least a portion of the expedition route includes the position marker corresponding to the obstacle position and a position marker of the target team. Specifically, the current position of the target team, the obstacle position, and the position of the first scene plot, etc. may be indicated in the scene map, thereby enabling the player to learn about the relative position of the obstacle position with respect to the target team, so as to facilitate the player to make decisions on the selection of the expedition team, whether to capture the obstacle position, etc.

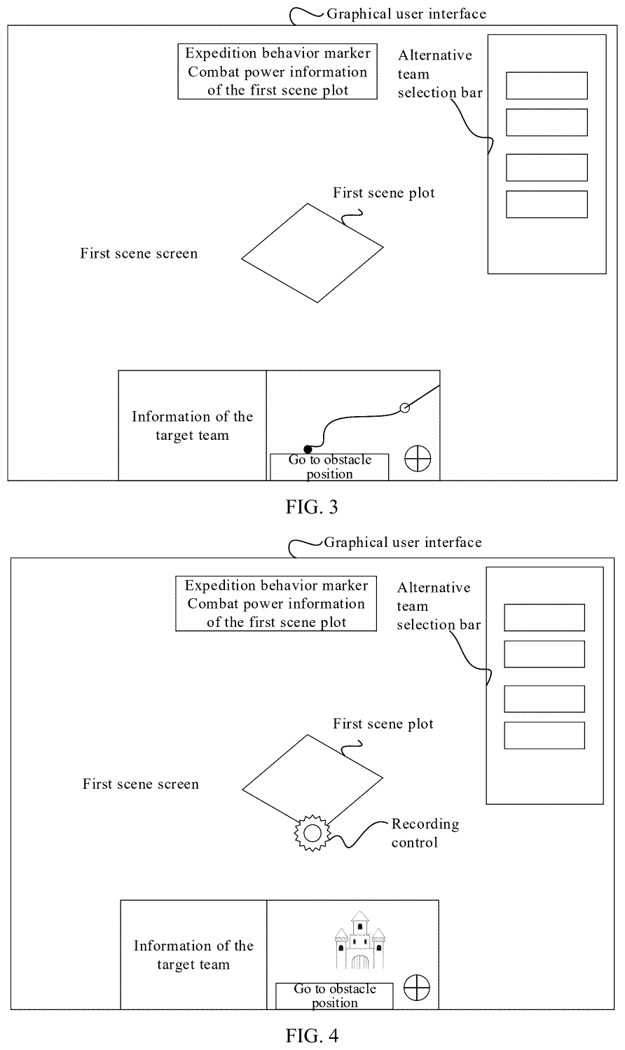

FIG. 3 is taken as an example. In this example, a scene map is displayed in the sub-control that originally displays the expedition route information. The black dot is the position marker of the target team, and the hollow dot is the marker of the obstacle position. Through the obstacle prompt information, the player can know the distance, location and other information of the obstacle position relative to the target team.

In this embodiment, in the case that obstacle exists on the expedition route and in the case that no obstacle exists on the expedition route, the expedition information displayed in the expedition information control is different. The specific description is as follows.

In response to the absence of the obstacle position on the expedition route, first expedition information is displayed in the expedition information control; where the first expedition information includes expedition route information, and the expedition route information includes more than one of the following: time consumed for an expedition, time when the target team arrives at the first scene plot, an increased experience value, a resource spent on the expedition, a supply control, and an expedition trigger control.

In actual implementation, the above-mentioned expedition information control may be divided into a plurality of sub-controls, and each of the sub-controls is distributed at the respective position in the graphical user interface, such as the top, bottom, side, etc. In addition to the above-mentioned expedition route information, the above-mentioned first expedition information may further include one or more of the following: an expedition behavior marker, plot information of the first scene plot, target team information, alternative team information, and a selection control for whether to return automatically. The first expedition information may be distributed and displayed in the above-mentioned plurality of sub-controls to minimize the obstruction of the scene screen by the expedition information control.

In one manner, the above-mentioned expedition route information in the first expedition information may be displayed in one sub-control. For example, this sub-control may be located at the bottom of the graphical user interface.

In response to the obstacle position existing on the expedition route, second expedition information is displayed in the expedition information control; where the second expedition information includes the obstacle prompt information for the obstacle position, and the obstacle prompt information is displayed at a specified position in the expedition information control; where the specified position is used for displaying only the obstacle prompt information or displaying only expedition route information, and when no obstacle position exists on the expedition route, the expedition route information is displayed on the specified position.

It should be noted here that information included in the second expedition information is different from the information included in the above-mentioned first expedition information. The second expedition information includes obstacle prompt information, which may specifically be the scene map mentioned above that includes the position marker of the obstacle position. The obstacle prompt information is displayed at a specified position in the expedition information control. In specific implementation, the specified position may be one sub-control in the expedition information control.

In the case that the obstacle exists on the expedition route and in the case that no obstacle exists on the expedition route, the content displayed at the specified position is different. When there is no obstacle on the route, the above-mentioned expedition route information is displayed at the specified position. When there is an obstacle(s) on the expedition route, the expedition route information is no longer displayed at the specified position, and instead, the obstacle prompt information is displayed.

It may also be understood that when there is no obstacle on the expedition route, the expedition route information is displayed on the specified position, and when there is the obstacle(s) on the expedition route, the expedition route information that should be displayed at the specified position is replaced by the above-mentioned obstacle prompt information.

The above manner considers that when there is the obstacle(s) on the expedition route, it is difficult to directly trigger the expedition operation based on the expedition route. In this case, displaying the expedition route information would be redundant. In order to reduce the obstruction of the scene screen by the information display, when there is the obstacle(s) on the expedition route, the expedition route information is no longer displayed. Instead, the above-mentioned obstacle prompt information is displayed in place of the expedition route information at the specified position where the expedition route information was displayed, so that the player can perform a further operation based on the obstacle prompt information. This manner can improve the efficiency of information display. Moreover, it reduces the running time of game session of the terminal device and saves the power consumption of the terminal device.

Furthermore, in addition to displaying the obstacle prompt information, the above second expedition information may further display one or more of the following: an expedition behavior marker, the plot information of the first scene plot, the target team information, the alternative team information, and a selection control for whether to automatically return. Such information may be the same as the relevant content of the above first expedition information. Furthermore, considering that the obstacle prompt information may only provide the player with preliminary information, if the player wants to further learn about the details of the obstacle position, this embodiment supports further operations on the obstacle prompt information.

Specifically, in response to a first viewing operation with respect to the obstacle prompt information, a second scene screen of the target game scene is displayed in the expedition information control; where the second scene screen includes a second scene plot where the obstacle position is located and building information on the second scene plot.

The first viewing operation may specifically be an operation on the obstacle prompt information. For example, if the obstacle prompt information is displaying the obstacle position in the form of a scene map, the first viewing operation may be a trigger operation on the position marker of the obstacle position in the scene map, such as a single-click operation, a double-click operation, etc. If the obstacle prompt information is in the form of text, and the text content has a triggerable attribute, the first viewing operation may be a trigger operation on a certain text content, such as a single-click operation.

In other manners, the obstacle prompt information may also be associated with setting of a viewing control, and the first viewing operation may be triggered by operating the viewing control. Continuing to refer to FIG. 3, the circular control with a “+” sign is the viewing control, and when the player clicks on the viewing control, the above second scene screen is displayed. After the player performs the first viewing operation, the second scene screen is displayed in the expedition information control, and the second scene screen includes the second scene plot where the obstacle position is located. At this time, the player can know the detailed information of the second scene plot where the obstacle position is located, such as the type of buildings on the second scene plot, the camp to which the second scene plot belongs, etc., so as to decide whether to occupy the second scene plot.

FIG. 4 is taken as an example, the second scene screen is shown in the expedition information control, and in the second scene screen, a building model of the plot where the obstacle position is located is displayed, so that the player can know the type of the building model at the obstacle position to adopt different handling methods. For example, if the building model belongs to a player from another camp, in this case, it may be necessary to occupy the second scene plot. If the building model belongs to a building set by the system level, it is necessary to handle the obstacle position according to the requirement of the system level.

In addition, when displaying the second scene screen, one viewing control may also be displayed on the second scene screen, such as the circular control marked with a “+” sign in FIG. 4. By clicking the viewing control, the second scene screen may be switched back to the screen displaying the obstacle prompt information in the expedition information control, for example, the above-mentioned obstacle prompt information in the form of the scene map. Alternatively, when the viewing control is clicked, further detailed information of the second scene plot may continue to be displayed.

Through the above manner, the player can further view the detailed information of the building at the obstacle position, which is conductive to the player making further decisions.

In another manner, if the player feels that the relevant information of the obstacle position viewed through the expedition information control is relatively limited, in this case, the player may perform a switching operation on the scene screen of the graphical user interface. Specifically, in response to a second viewing operation on the obstacle prompt information, the first scene screen is switched to a second scene screen in the graphical user interface; where the second scene screen includes a second scene plot where the obstacle position is located.

In this case, the first scene screen is switched to the second scene screen. If the obstacle position is far from the position of the first scene plot, in this case, the first scene plot is usually no longer displayed in the second scene screen, and only the second scene plot where the obstacle position is located is displayed. When the viewing field of the second scene screen is large, the surrounding plot(s) of the second scene plot may also be displayed, so that the player can clearly learn about the situation of the plot at the obstacle position and the situation around the plot. During the process of switching the first scene screen to the second scene screen in the graphical user interface, the virtual camera may be controlled to gradually move to the position corresponding to the second scene screen. In this case, the graphical user interface gradually changes and transitions from the first scene screen to the second scene screen. The position of the virtual camera may also be controlled to directly reach the position corresponding to the second scene screen. In this case, in the graphical user interface, the second scene screen directly replaces the first scene screen, and there is no transition of the scene screen, thereby effectively reducing the running time of game session of the terminal device and saving the power consumption of the terminal device.

Continuing to refer to FIG. 3, the second viewing operation may be realized by triggering the “Go to obstacle position” control, thereby controlling the scene screen in the graphical user interface to be switched. In another way, as shown in FIG. 4, when the second scene screen including the second scene plot where the obstacle position is located has already been displayed in the expedition information control, the scene screen in the graphical user interface may also be controlled to be switched by triggering the “Go to obstacle position” control, thereby displaying the second scene screen in a larger viewing field of through the graphical user interface, so that the player can obtain more abundant information about the obstacle position.

In other manners, after the second viewing operation is triggered, the graphical user interface may display the first scene screen and the second scene screen in a split screen mode. In this case, the graphical user interface may be divided into two areas to simultaneously display the first scene screen and the second scene screen. Each scene screen may be provided with a control for enlarging or closing the screen. Taking the first scene screen as an example, if the first scene screen is closed, the split screen mode in the graphical user interface is canceled, and only the second scene screen is displayed; if the first scene screen is enlarged, the split screen mode in the graphical user interface is canceled, and only the first scene screen is displayed.

In the above solution, the scene screen in the graphical user interface is switched. If the player wants to return to the position of the first scene plot again, the player needs to search for and drag the scene screen multiple times, and thus loses the positioning of the first scene plot. If the jump to the map system is caused by the player's misoperation, it will further affect the player's gaming experience.

In order to enable the player to switch conveniently among the scene screens corresponding to a plurality of scene plots, in this embodiment, the graphical user interface includes a recording control. The recording control is used to record a plot position of the first scene plot. In response to a trigger operation on the recording control, the plot position of the first scene plot is recorded. Continuing to refer to FIG. 4, a recording control is displayed near the first scene plot, and the recording control may provide the player with an approach to quickly return to the first scene plot. When the trigger operation is performed on the recording control, the game system may record coordinates of the plot position of the first scene plot, and may also record the position coordinates of the virtual camera in the target game scene when the virtual camera shoots the first scene plot.

After the player clicks the recording control and then clicks the “Go to obstacle position” control, the first scene screen is switched to the second scene screen in the graphical user interface. In response to the switching of the first scene screen to the second scene screen in the graphical user interface, a position return control is displayed; where the position return control is used to control the graphical user interface to display the first scene screen based on the recorded plot position of the first scene plot.

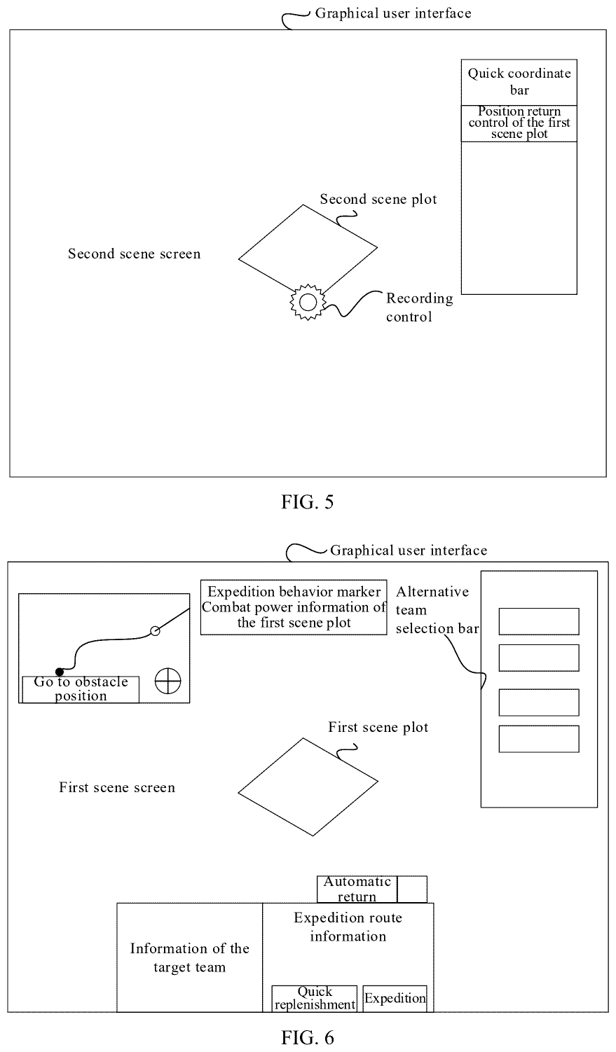

Referring to FIG. 5, the graphical user interface currently displays the second scene screen, which includes the second scene plot. At the same time, a quick coordinate bar is provided on the right side of the graphical user interface, in the quick coordinate bar, the position return control of the first scene plot is displayed. After the position return control is triggered, the first scene screen including the first scene plot are displayed in the graphical user interface again. Thus, the player can conveniently switch back to the scene screen of the first scene plot without the need to search for and drag the scene screen multiple times.

In addition, the player may use the above-mentioned recording control to record the positions of a plurality of plots, which are then displayed in the quick coordinate bar. For example, when the graphical user interface displays the second scene plot, the player may record the position of the second scene plot by the recording control. Then, when the graphical user interface displays other plots, the position return control of the second scene plot is displayed in the quick coordinate bar. By triggering the position return control, the player may control the graphical user interface to display the second scene plot again.

When there are a plurality of obstacle positions on the expedition route, the recording control may also be used to record the plot positions of the plots where the obstacle positions are located, so that the player can quickly view each scene plot of which the plot position is recorded through the quick coordinate bar.

In another implementation, in response to a second viewing operation on the obstacle prompt information, a recording prompt control is displayed in the graphical user interface; where the recording prompt control is used to prompt whether to record the plot position of the first scene plot in the first scene screen; and in response to a specified operation on the recording prompt control, the first scene screen is switched to the second scene screen in the graphical user interface.

The second viewing operation is used to control the switching of scene screens in the graphic user interface. If the recording control is not triggered before the second viewing operation is triggered, or the recording control is not provided in the graphical user interface, after the second viewing operation is triggered, the recording prompt control is displayed in the graphical user interface. The recording prompt control may be displayed in the form of a window above the scene screen, and the recording prompt control may display information such as “Whether to record the plot position of the first scene plot” or “Whether to collect the first scene plot”, and may also display sub-controls of “Yes” and “No”, and a sub-control for closing the recording prompt control.

The above-mentioned specified operation may include an operation for triggering any sub-control in the recording prompt control. If the sub-control displaying “No” is triggered, or the sub-control for closing the recording prompt control is triggered, in this case, the plot position of the first scene plot is not recorded, and then the second scene screen is displayed in the graphical user interface. If the sub-control displaying “Yes” is triggered, in this case, the plot position of the first scene plot is recorded, and at the same time, the second scene screen is displayed in the graphical user interface.

In the above manner, by displaying the recording prompt control, the player may be reminded to record the position of the first scene plot, thereby preventing the player from forgetting, which makes it difficult to locate the first scene plot later.

Furthermore, in response to a recording confirmation operation on the recording prompt control, the first scene screen is switched to the second scene screen in the graphical user interface. A position return control is displayed in the graphical user interface, where the position return control is used to control the graphical user interface to display the first scene screen.

After recording the plot position of the first scene plot through the recording prompt control, when the graphical user interface displays the second scene screen, the position return control corresponding to the first scene screen is displayed, and the position return control may also be displayed in the quick coordinate bar in FIG. 5.

There is another implementation, which realizes automatic recording of the first scene plot without the user operating the control. In response to the second viewing operation on the obstacle prompt information, the plot position of the first scene plot is recorded; the first scene screen is switched to the second scene screen in the graphical user interface; where the second scene screen includes the second scene plot where the obstacle position is located; and the position return control is displayed; where the position return control is used to control the graphical user interface to display the first scene screen based on the recorded plot position of the first scene plot.

After the second viewing operation is triggered, the plot position of the first scene plot is directly recorded, and then the first scene screen is switched to the second scene screen, and a position return control is displayed at the same time. In this way, the automatic recording of the plot position can be realized without the need for the user to trigger the recording control. After the scene screen is switched, the position return control for the original plot is displayed in the graphical user interface, which further improves the convenience of the position jump operation. It further reduces the running time of game session on the terminal device and saves the power consumption of the terminal device.

In other implementations, in response to the presence of the obstacle position on the expedition route, and there are a plurality of obstacle positions, the position prompt information of a first obstacle position closest to the target team is displayed in the expedition information control. Generally, if the player wants to clear the obstacle positions on the expedition route, he/she needs to proceed in order from near to far. Meanwhile, taking the limited display area of the expedition information control into account, when there are a plurality of obstacle positions on the expedition route, the position prompt information of the first obstacle position closest to the target team is displayed to provide the player with necessary obstacle prompt while ensuring that the information prompt is highly concise.

In one example, the obstacle prompt information is displayed in the form of a scene map, in which case the scene map includes a position marker of the first obstacle position closest to the target object. In addition, information such as the number and location of other obstacle positions may be briefly indicated in text.

Furthermore, in response to the presence of a plurality of expedition routes, route information of each of the expedition routes and a selection control for each of the expedition routes are displayed in the expedition information control; where the selection control is used to select a corresponding expedition route to control the target team to march to the first scene plot along the selected expedition route; and in response to the obstacle position existing on a first expedition route in the plurality of expedition routes, obstacle prompt information of the obstacle position on the first expedition route is displayed in the expedition information control. In this manner, there are a plurality of expedition routes between the target team and the first scene position; the expedition information control includes the route information of each of the expedition routes, and one can choose which expedition route is used for the expedition via the selection control. For the first expedition route on which the obstacle position exists, the obstacle prompt information of the obstacle position may be directly displayed in the expedition information control, or the obstacle prompt information of the obstacle position may be displayed after the first expedition route is selected. The manner for displaying the obstacle prompt information may refer to the manners in the above-mentioned embodiments, which will not be repeated herein.

In this manner, a plurality of expedition routes and the obstacle prompt information of the obstacle positions on the expedition routes are displayed in the expedition information control. The player can decide which expedition route to choose based on the obstacle prompt information, without the need to jump to the map system to check the obstacle positions on the expedition routes one by one, which improves the convenience of the expedition operation. It is conducive to reducing the running time of the game session on the terminal device and saving the power consumption of the terminal device.

In addition, FIG. 6 illustrates a method of displaying the obstacle prompt information through a separate window. The window, as a sub-control in the expedition information control, may display the obstacle prompt information in the form of a map, or may display a scene screen containing the obstacle position. This method can realize the simultaneous display of the obstacle prompt information and the expedition route information.

The above display control method of the game integrates march obstruction information prompts into the expedition operation process, modifies the information content of the expedition pop-up window, allows the player to quickly identify the current state as march obstruction, and provides a convenient collection function, thereby allowing the player to record the current position and then jump to view the obstacle point. The operation process is simpler and faster. For novice players, the comparison between the scene and the map is realized, which facilitates quick cognition. At the same time, it avoids the loss of the original scene position due to the misoperation, has a certain error prevention mechanism, and improves the player's gaming experience.

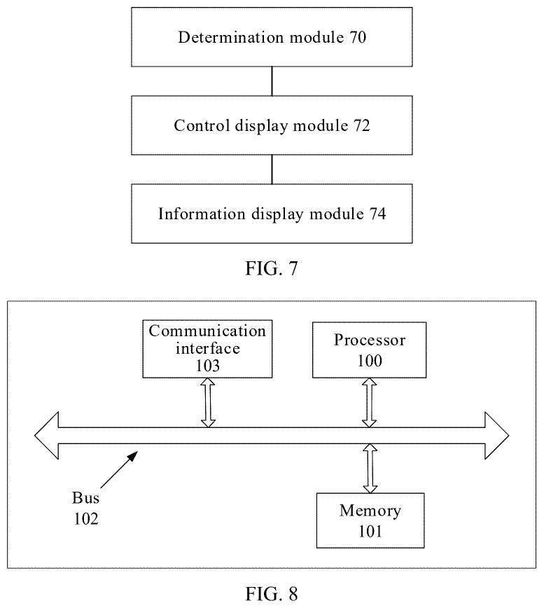

Corresponding to the above method embodiments, referring to the schematic structural diagram of a display control apparatus for a game as shown in FIG. 7, a graphical user interface is provided by a terminal device, and the graphical user interface includes a first scene screen of a target game scene; the target game scene includes a plurality of scene plots; where the apparatus includes:
a determination module 70, configured to, in response to a trigger operation on a first scene plot in the first scene screen, determine an expedition route for a target team to march to the first scene plot;
a control display module 72, configured to display an expedition information control on the first scene screen, where the expedition information control is used for displaying expedition information of the target team marching to the first scene plot; and
an information display module 74, configured to, in response to an obstacle position existing on the expedition route, display obstacle prompt information for the obstacle position in the expedition information control; where the obstacle prompt information includes: position information of at least one obstacle position on the expedition route.

In the above display control apparatus for the game, a graphical user interface is provided by a terminal device, where the graphical user interface includes a first scene screen of a target game scene, and the target game scene includes a plurality of scene plots. In response to a trigger operation on a first scene plot in the first scene screen, an expedition route for a target team to march to the first scene plot is determined. An expedition information control is displayed on the first scene screen, where the expedition information control is used for displaying expedition information of the target team marching to the first scene plot. In response to an obstacle position existing on the expedition route, obstacle prompt information for the obstacle position is displayed in the expedition information control, where the obstacle prompt information includes: position information of at least one obstacle position on the expedition route. In this manner, when the player is performing the expedition operation, if there is an obstacle position in the expedition route, the obstacle prompt information can be displayed in the expedition information control, so that the player can learn about the situation of the obstacle position without jumping to the map system to display the information of the obstacle position and without the cost of recognition and cognition when comparing and checking between the scene and the map, thereby improving the gaming experience of the player.

The above information display module is further configured to: in response to the obstacle position existing on the expedition route, display at least a portion of a scene map of the target game scene in the expedition information control; where the at least a portion of the scene map includes a position marker corresponding to the obstacle position.

The above apparatus further includes a route display module, which is configured to: display at least a portion of the expedition route in the at least a portion of the scene map; where the at least a portion of the expedition route includes the position marker corresponding to the obstacle position and a position marker of the target team.

The above apparatus further includes a first display module, which is configured to: in response to no obstacle position existing on the expedition route, display first expedition information in the expedition information control; where the first expedition information includes expedition route information, and the expedition route information includes more than one of following: time consumed for an expedition, time when the target team arrives at the first scene plot, an increased experience value, a resource spent on the expedition, a supply control, and an expedition trigger control.

The above apparatus further includes a second display module, which is configured to: in response to the obstacle position existing on the expedition route, display second expedition information in the expedition information control; where the second expedition information includes the obstacle prompt information for the obstacle position, and the obstacle prompt information is displayed at a specified position in the expedition information control; where the specified position is used for displaying only the obstacle prompt information or displaying only expedition route information, and when no obstacle position exists on the expedition route, the expedition route information is displayed on the specified position.

The second expedition information further includes one or more of following: an expedition behavior marker, plot information of the first scene plot, information of the target team, information of an alternative team, and a selection control for whether to return automatically. The above apparatus further includes a screen display module, which is configured to: in response to a first viewing operation on the obstacle prompt information, display a second scene screen of the target game scene in the expedition information control; where the second scene screen includes a second scene plot where the obstacle position is located and building information on the second scene plot.

The above apparatus further includes a screen switching module, which is configured to: in response to a second viewing operation on the obstacle prompt information, switch the first scene screen to a second scene screen in the graphical user interface; where the second scene screen includes a second scene plot where the obstacle position is located.

The above graphical user interface includes a recording control, where the recording control is configured to: record a plot position of the first scene plot; and the above apparatus further includes a recording module, which is configured to: in response to a trigger operation on the recording control, record the plot position of the first scene plot.

The above apparatus further includes a returning module, which is configured to: in response to switching the first scene screen to the second scene screen in the graphical user interface, displaying a position return control; where the position return control is used to control the graphical user interface to display the first scene screen based on the recorded plot position of the first scene plot.

The above apparatus further includes a switching control module, which is configured to: in response to a second viewing operation on the obstacle prompt information, display a recording prompt control in the graphical user interface; where the recording prompt control is configured to prompt whether to record a plot position of the first scene plot in the first scene screen; and in response to a specified operation on the recording prompt control, switch the first scene screen to a second scene screen in the graphical user interface.

The above switching control module is further configured to: in response to a recording confirmation operation on the recording prompt control, switch the first scene screen to the second scene screen in the graphical user interface; and display a position return control in the graphical user interface, where the position return control is configured to control the graphical user interface to display the first scene screen.

The above apparatus further includes a display control module, which is configured to: in response to a second viewing operation on the obstacle prompt information, record a plot position of the first scene plot; switch the first scene screen to a second scene screen in the graphical user interface; where the second scene screen includes a second scene plot where the obstacle position is located; and display a position return control; where the position return control is configured to control the graphical user interface to display the first scene screen based on a recorded plot position of the first scene plot.

The above information display module is further configured to: in response to an obstacle position existing on the expedition route and the number of the obstacle position is multiple, display position prompt information of a first obstacle position closest to the target team in the expedition information control.

The above apparatus further includes a route information display control module, which is configured to: in response to a presence of a plurality of expedition routes, display route information of each of the expedition routes and a selection control of each of the expedition routes in the expedition information control; where the selection control is configured to select a corresponding expedition route to control the target team to march to the first scene plot along the selected expedition route; and in response to the obstacle position existing on a first expedition route in the plurality of expedition routes, display the obstacle prompt information of the obstacle position on the first expedition route in the expedition information control.

The embodiment further provides an electronic device, including a processor and a memory, where the memory stores machine-executable instructions that can be executed by the processor, and the processor executes the machine-executable instructions to implement the above display control method for the game. The electronic device may be a server or a touch terminal device. As shown in FIG. 8, the electronic device includes a processor 100 and a memory 101. The memory 101 stores machine-executable instructions that can be executed by the processor 100. The processor 100 executes the machine-executable instructions to implement the display control method for the game.

Furthermore, the electronic device shown in FIG. 8 further includes a bus 102 and a communication interface 103, and the processor 100, the communication interface 103 and the memory 101 are connected via the bus 102.

The memory 101 may include a high-speed random access memory (RAM), and may also include a non-volatile memory, such as at least one disk memory. The communication connection between the system network element and at least one other network element is realized through at least one communication interface 103 (which may be wired or wireless), and the Internet, wide area network, local area network, metropolitan area network, etc. may be used. The bus 102 may be an ISA bus, a PCI bus or an EISA bus, etc. The bus may be divided into an address bus, a data bus, a control bus, etc. For ease of representation, only one bidirectional arrow is used in FIG. 8 for representation, but it does not mean that there is only one bus or one type of bus.

The processor 100 may be an integrated circuit chip with signal processing capabilities. In the implementation process, each step of the above method may be completed by the hardware integrated logic circuit or instructions in software form in the processor 100. The above processor 100 may be a general-purpose processor, including a central processing unit (CPU), a network processor (NP), etc., it may also be a digital signal processor (DSP), an application specific integrated circuit (ASIC), a field-programmable gate array (FPGA), or other programmable logic devices, discrete gates or transistor logic devices, discrete hardware components, which can implement or execute the disclosed methods, steps and logic block diagrams in the embodiments of the present disclosure. The general-purpose processor may be a microprocessor or the processor may also be any conventional processor, etc. The steps of the methods disclosed with reference to the embodiments of the present disclosure may be directly embodied as being executed and completed by a hardware decoding processor, or may be embodied as being executed and completed by a combination of hardware and software modules in a decoding processor. The software module may be located in a random access memory, flash memory, read-only memory, programmable read-only memory or electrically erasable programmable memory, registers, and other mature storage media in the art. The storage medium is located in the memory 101, and the processor 100 reads the information in the memory 101 and completes the steps of the methods of the above embodiments in conjunction with its hardware. For example:

In the display control method for the game, a graphical user interface is provided by a terminal device, where the graphical user interface includes a first scene screen of a target game scene, and the target game scene includes a plurality of scene plots. In response to a trigger operation on a first scene plot in the first scene screen, an expedition route for a target team to march to the first scene plot is determined. An expedition information control is displayed on the first scene screen, where the expedition information control is used for displaying expedition information of the target team marching to the first scene plot. In response to an obstacle position existing on the expedition route, obstacle prompt information for the obstacle position is displayed in the expedition information control, where the obstacle prompt information includes: position information of at least one obstacle position on the expedition route.

In this manner, when the player is performing the expedition operation, if there is an obstacle position in the expedition route, the obstacle prompt information can be displayed in the expedition information control, so that the player can learn about the situation of the obstacle position without jumping to the map system to display the information of the obstacle position and without the cost of recognition and cognition when comparing and checking between the scene and the map, thereby improving the gaming experience of the player.

In response to the obstacle position existing on the expedition route, at least a portion of a scene map of the target game scene is displayed in the expedition information control; where the at least a portion of the scene map includes a position marker corresponding to the obstacle position.

At least a portion of the expedition route is displayed in the at least a portion of the scene map; where the at least a portion of the expedition route includes the position marker corresponding to the obstacle position and a position marker of the target team.

In response to the absence of the obstacle position on the expedition route, first expedition information is displayed in the expedition information control; where the first expedition information includes expedition route information, and the expedition route information includes more than one of following: time consumed for an expedition, time when the target team arrives at the first scene plot, an increased experience value, a resource spent on the expedition, a supply control, and an expedition trigger control.

In response to the obstacle position existing on the expedition route, second expedition information is displayed in the expedition information control; where the second expedition information includes the obstacle prompt information for the obstacle position, and the obstacle prompt information is displayed at a specified position in the expedition information control; where the specified position is used for displaying only the obstacle prompt information or displaying only expedition route information, and when no obstacle position exists on the expedition route, the expedition route information is displayed at the specified position.

The above second expedition information further includes one or more of following: an expedition behavior marker, plot information of the first scene plot, information of the target team, information of an alternative team, and a selection control for whether to return automatically.

The above method can enable the player to learn about the relative position of the obstacle position with respect to the target team, so as to facilitate the player to make decisions on the selection of the expedition team, whether to capture the obstacle position, etc.

In response to a first viewing operation on the obstacle prompt information, a second scene screen of the target game scene is displayed in the expedition information control; where the second scene screen includes a second scene plot where the obstacle position is located and building information on the second scene plot.

Through the above manner, players can further view the detailed information of the buildings at the obstacle position, which is helpful for players to make further decisions.

In response to a second viewing operation on the obstacle prompt information, the first scene screen is switched to a second scene screen in the graphical user interface; where the second scene screen includes a second scene plot where the obstacle position is located.

This manner displays the second scene screen with a larger field of view through the graphical user interface, thereby allowing players to obtain richer information about the obstacle positions. The above graphical user interface includes a recording control; the recording control is configured to: record a plot position of the first scene plot; and in response to a trigger operation on the recording control, the plot position of the first scene plot is recorded.

In response to switching the first scene screen to the second scene screen in the graphical user interface, a position return control is displayed; where the position return control is configured to control the graphical user interface to display the first scene screen based on the recorded plot position of the first scene plot.

Through the above manner, the player can easily switch back to the scene screen of the first scene plot without having to search and drag the scene screen multiple times.

In response to a second viewing operation on the obstacle prompt information, a recording prompt control is displayed in the graphical user interface; where the recording prompt control is used to prompt whether to record a plot position of the first scene plot in the first scene screen; and in response to a specified operation on the recording prompt control, the first scene screen is switched to a second scene screen in the graphical user interface.

In the above manner, by displaying the recording prompt control, the player can be prompted to record the position of the first scene plot, thereby preventing the player from forgetting and avoiding difficulties in locating the first scene plot subsequently.

In response to a recording confirmation operation on the recording prompt control, the first scene screen is switched to the second scene screen in the graphical user interface; and a position return control is displayed in the graphical user interface, where the position return control is configured to control the graphical user interface to display the first scene screen.

In response to a second viewing operation on the obstacle prompt information, a plot position of the first scene plot is recorded; the first scene screen is switched to a second scene screen in the graphical user interface; where the second scene screen includes a second scene plot where the obstacle position is located; and a position return control is displayed; where the position return control is configured to control the graphical user interface to display the first scene screen based on a recorded plot position of the first scene plot.

In this manner, the automatic recording for the plot position can be achieved without requiring the user to trigger the recording control. After the scene screen is switched, the position return control of the original plot is displayed in the graphical user interface, thereby further improving the convenience of the position jump operation.

In response to the presence of a plurality of obstacle positions on the expedition route, position prompt information of a first obstacle position closest to the target team is displayed in the expedition information control.

In response to a presence of a plurality of expedition routes, route information of each of the expedition routes and a selection control of each of the expedition routes are displayed in the expedition information control; where the selection control is configured to select a corresponding expedition route to control the target team to march to the first scene plot along the selected expedition route.

In response to the obstacle position existing on a first expedition route in the plurality of expedition routes, the obstacle prompt information of the obstacle position on the first expedition route is displayed in the expedition information control.

In this manner, a plurality of expedition routes and obstacle prompt information of the obstacle positions on the expedition routes are displayed in the expedition information control. The players can decide which expedition route to choose based on the obstacle prompt information, without having to jump to the map system to check the obstacle positions on the expedition routes one by one, thereby improving the convenience of the expedition operation.

This embodiment further provides a machine-readable storage medium, which stores machine-executable instructions. When the machine-executable instructions are called and executed by a processor, the machine-executable instructions prompt the processor to implement the above display control method for the game, for example:

In the display control method for the game, a graphical user interface is provided by a terminal device, where the graphical user interface includes a first scene screen of a target game scene, and the target game scene includes a plurality of scene plots. In response to a trigger operation on a first scene plot in the first scene screen, an expedition route for a target team to march to the first scene plot is determined. An expedition information control is displayed on the first scene screen, where the expedition information control is used for displaying expedition information of the target team marching to the first scene plot. In response to an obstacle position existing on the expedition route, obstacle prompt information for the obstacle position is displayed in the expedition information control, where the obstacle prompt information includes: position information of at least one obstacle position on the expedition route.

In this manner, when the player is performing the expedition operation, if there is an obstacle position in the expedition route, the obstacle prompt information can be displayed in the expedition information control, so that the player can learn about the situation of the obstacle position without jumping to the map system to display the information of the obstacle position and without the cost of recognition and cognition when comparing and checking between the scene and the map, thereby improving the gaming experience of the player.

In response to the obstacle position existing on the expedition route, at least a portion of a scene map of the target game scene is displayed in the expedition information control; where the at least a portion of the scene map includes a position marker corresponding to the obstacle position.

At least a portion of the expedition route is displayed in the at least a portion of the scene map; where the at least a portion of the expedition route includes the position marker corresponding to the obstacle position and a position marker of the target team.

In response to the absence of the obstacle position on the expedition route, first expedition information is displayed in the expedition information control; where the first expedition information includes expedition route information, and the expedition route information includes more than one of following: time consumed for an expedition, time when the target team arrives at the first scene plot, an increased experience value, a resource spent on the expedition, a supply control, and an expedition trigger control.

In response to the obstacle position existing on the expedition route, second expedition information is displayed in the expedition information control; where the second expedition information includes the obstacle prompt information for the obstacle position, and the obstacle prompt information is displayed at a specified position in the expedition information control; where the specified position is used for displaying only the obstacle prompt information or displaying only expedition route information, and when no obstacle position exists on the expedition route, the expedition route information is displayed at the specified position.

The above second expedition information further includes one or more of following: an expedition behavior marker, plot information of the first scene plot, information of the target team, information of an alternative team, and a selection control for whether to return automatically.

The above method can enable the player to learn about the relative position of the obstacle position with respect to the target team, so as to facilitate the player to make decisions on the selection of the expedition teams, whether to capture the obstacle position, etc.

In response to a first viewing operation on the obstacle prompt information, a second scene screen of the target game scene is displayed in the expedition information control; where the second scene screen includes a second scene plot where the obstacle position is located and building information on the second scene plot.

Through the above manner, players can further view the detailed information of the buildings at the obstacle position, which is helpful for players to make further decisions.

In response to a second viewing operation on the obstacle prompt information, the first scene screen is switched to a second scene screen in the graphical user interface; where the second scene screen includes a second scene plot where the obstacle position is located.

This manner displays the second scene screen with a larger field of view through the graphical user interface, thereby allowing players to obtain richer information about the obstacle positions. The above graphical user interface includes a recording control; the recording control is configured to: record a plot position of the first scene plot; and in response to a trigger operation on the recording control, the plot position of the first scene plot is recorded.

In response to switching the first scene screen to the second scene screen in the graphical user interface, a position return control is displayed; where the position return control is configured to control the graphical user interface to display the first scene screen based on the recorded plot position of the first scene plot.

Through the above manner, the player can easily switch back to the scene screen of the first scene plot without having to search and drag the scene screen multiple times.

In response to a second viewing operation on the obstacle prompt information, a recording prompt control is displayed in the graphical user interface; where the recording prompt control is used to prompt whether to record a plot position of the first scene plot in the first scene screen; and in response to a specified operation on the recording prompt control, the first scene screen is switched to a second scene screen in the graphical user interface.

In the above manner, by displaying the recording prompt control, the player can be prompted to record the position of the first scene plot, thereby preventing the player from forgetting and avoiding difficulties in locating the first scene plot subsequently.

In response to a recording confirmation operation on the recording prompt control, the first scene screen is switched to the second scene screen in the graphical user interface; and a position return control is displayed in the graphical user interface, where the position return control is configured to control the graphical user interface to display the first scene screen.

In response to a second viewing operation on the obstacle prompt information, a plot position of the first scene plot is recorded; the first scene screen is switched to a second scene screen in the graphical user interface; where the second scene screen includes a second scene plot where the obstacle position is located; and a position return control is displayed; where the position return control is configured to control the graphical user interface to display the first scene screen based on a recorded plot position of the first scene plot.

In this manner, the automatic recording for the plot position can be achieved without requiring the user to trigger the recording control. After the scene screen is switched, the position return control of the original plot is displayed in the graphical user interface, thereby further improving the convenience of the position jump operation.

In response to the presence of a plurality of obstacle positions on the expedition route, position prompt information of a first obstacle position closest to the target team is displayed in the expedition information control.

In response to a presence of a plurality of expedition routes, route information of each of the expedition routes and a selection control of each of the expedition routes are displayed in the expedition information control; where the selection control is configured to select a corresponding expedition route to control the target team to march to the first scene plot along a selected expedition route.

In response to the obstacle position existing on a first expedition route in the plurality of expedition routes, the obstacle prompt information of the obstacle position on the first expedition route is displayed in the expedition information control.

In this manner, a plurality of expedition routes and obstacle prompt information of the obstacle positions on the expedition routes are displayed in the expedition information control. The players can decide which expedition route to choose based on the obstacle prompt information, without having to jump to the map system to check the obstacle positions on the expedition routes one by one, thereby improving the convenience of the expedition operation.

The display control method and apparatus for the game and computer program product of the electronic device provided in the embodiments of the present disclosure include a computer-readable storage medium storing program codes thereon. The instructions included in the program code may be used to execute the methods described in the previous method embodiments. The specific implementation may refer to the method embodiments, which will not be repeated herein.

Those skilled in the art can clearly understand that, for the convenience and brevity of description, the specific working process of the system and apparatus described above may refer to the corresponding process in the aforementioned method embodiments, and will not be repeated herein.

In addition, in the description of the embodiments of the present disclosure, unless otherwise explicitly specified and limited, the terms “installed”, “connected”, and “connection” should be understood in a broad sense, for example, they may be a fixed connection, a detachable connection, or an integral connection; they may be a mechanical connection or an electrical connection; they may be a direct connection or indirect connection through an intermediate medium, or they may be the internal communication of two components. For those skilled in the art, the specific meanings of the above terms in the present disclosure may be understood according to specific circumstances.

If the functions are implemented in the form of software functional units and sold or used as independent products, they can be stored in a computer-readable storage medium. Based on this understanding, the essence of the technical solution, or the part that contributes to the prior art or the part of the technical solution of the present disclosure, may be embodied in the form of a software product. The computer software product is stored in a storage medium, which includes several instructions to enable a computer device (which may be a personal computer, a server, or a network device, etc.) to perform all or part of the steps of the method described in each embodiment of the present disclosure. The aforementioned storage medium includes: a USB flash drive, a removable hard disk, a read-only memory (ROM), a random access memory (RAM), a disk or optical disk, and other media that can store program codes.

In the description of the present disclosure, it should be noted that the orientation or positional relationship indicated by the terms “center”, “upper”, “lower”, “left”, “right”, “vertical”, “horizontal”, “inner”, “outer”, etc., are based on the orientation or positional relationship shown in the accompanying drawings, and are only for the ease of describing the present disclosure and simplifying the description, rather than indicating or implying that the apparatus or element referred to must have a specific orientation, be constructed and operated in a specific orientation, and therefore cannot be understood as a limitation of the present disclosure. In addition, the terms “first”, “second”, and “third” are used for descriptive purposes only, and cannot be understood as indicating or implying relative importance.

Finally, it should be noted that the above embodiments are only specific implementation manners of the present disclosure, which are used to illustrate the technical solutions of the present disclosure, rather than to limit them. The protection scope of the present disclosure is not limited thereto. Although the present disclosure is described in detail with reference to the above embodiments, those skilled in the art should understand that any technician familiar with the technical field can still modify the technical solutions recorded in the foregoing embodiments, or easily think of changes, or make equivalent replacements for some of the technical features therein within the technical scope disclosed in the present disclosure, and these modifications, changes or replacements do not make the essence of the corresponding technical solutions deviate from the spirit and scope of the technical solutions of the embodiments of the present disclosure, and should be included in the protection scope of the present disclosure. Therefore, the protection scope of the present disclosure should be subject to the protection scope of the claims.

1. A display control method for a game, wherein a graphical user interface is provided by a terminal device, the graphical user interface comprises a first scene screen of a target game scene, and the target game scene comprises a plurality of scene plots; wherein the method comprises:
in response to a trigger operation on a first scene plot in the first scene screen, determining an expedition route for a target team to march to the first scene plot;
displaying an expedition information control on the first scene screen, wherein the expedition information control is used to display expedition information of the target team marching to the first scene plot; and
in response to an obstacle position existing on the expedition route, displaying obstacle prompt information for the obstacle position in the expedition information control; wherein the obstacle prompt information comprises: position information of at least one obstacle position on the expedition route.

2. The method according to claim 1, wherein displaying the obstacle prompt information for the obstacle position in the expedition information control in response to the obstacle position existing on the expedition route comprises:
in response to the obstacle position existing on the expedition route, displaying at least a portion of a scene map of the target game scene in the expedition information control; wherein the at least a portion of the scene map comprises a position marker corresponding to the obstacle position.

3. The method according to claim 2, wherein after displaying the at least a portion of the scene map of the target game scene in the expedition information control in response to the obstacle position existing on the expedition route, the method further comprises:
displaying at least a portion of the expedition route in the at least a portion of the scene map;
wherein the at least a portion of the expedition route comprises the position marker corresponding to the obstacle position and a position marker of the target team.

4. The method according to claim 1, wherein the method further comprises:
in response to no obstacle position existing on the expedition route, displaying first expedition information in the expedition information control;
wherein the first expedition information comprises expedition route information, and the expedition route information comprises more than one of: time consumed for an expedition, time when the target team arrives at the first scene plot, an increased experience value, a resource spent on the expedition, a supply control, and an expedition trigger control.

5. The method according to claim 1, wherein the method further comprises:
in response to the obstacle position existing on the expedition route, displaying second expedition information in the expedition information control;
wherein the second expedition information comprises the obstacle prompt information for the obstacle position, and the obstacle prompt information is displayed at a specified position in the expedition information control; wherein the specified position is used to display only the obstacle prompt information or displaying only expedition route information, and when no obstacle position exists on the expedition route, the specified position is used to display the expedition route information.

6. The method according to claim 5, wherein the second expedition information further comprises one or more of: an expedition behavior marker, plot information of the first scene plot, information of the target team, information of an alternative team, and a selection control for whether to return automatically.

7. The method according to claim 1, wherein after displaying the obstacle prompt information for the obstacle position in the expedition information control in response to the obstacle position existing on the expedition route, the method further comprises:
in response to a first viewing operation on the obstacle prompt information, displaying a second scene screen of the target game scene in the expedition information control; wherein the second scene screen comprises a second scene plot where the obstacle position is located and building information on the second scene plot.

8. The method according to claim 1, wherein after displaying the obstacle prompt information for the obstacle position in the expedition information control in response to the obstacle position existing on the expedition route, the method further comprises:
in response to a second viewing operation on the obstacle prompt information, switching the first scene screen to a second scene screen in the graphical user interface; wherein the second scene screen comprises a second scene plot where the obstacle position is located.

9. The method according to claim 8, wherein the graphical user interface comprises a recording control, and the recording control is used to record a plot position of the first scene plot;
before switching the first scene screen to the second scene screen in the graphical user interface in response to the second viewing operation on the obstacle prompt information, the method further comprises:
in response to a trigger operation on the recording control, recording the plot position of the first scene plot.

10. The method according to claim 9, wherein the method further comprises:
in response to switching the first scene screen to the second scene screen in the graphical user interface, displaying a position return control; wherein the position return control is used to control the graphical user interface to display the first scene screen based on the recorded plot position of the first scene plot.

11. The method according to claim 1, wherein after displaying the obstacle prompt information for the obstacle position in the expedition information control in response to the obstacle position existing on the expedition route, the method further comprises:
in response to a second viewing operation on the obstacle prompt information, displaying a recording prompt control in the graphical user interface; wherein the recording prompt control is used to prompt whether to record a plot position of the first scene plot in the first scene screen; and
in response to a specified operation on the recording prompt control, switching the first scene screen to a second scene screen in the graphical user interface.

12. The method according to claim 11, wherein switching the first scene screen to the second scene screen in the graphical user interface in response to the specified operation on the recording prompt control, comprises:
in response to a recording confirmation operation on the recording prompt control, switching the first scene screen to the second scene screen in the graphical user interface; and
displaying a position return control in the graphical user interface, wherein the position return control is used to control the graphical user interface to display the first scene screen.

13. The method according to claim 1, wherein after displaying the obstacle prompt information for the obstacle position in the expedition information control in response to the obstacle position existing on the expedition route, the method further comprises:
in response to a second viewing operation on the obstacle prompt information, recording a plot position of the first scene plot;
switching the first scene screen to a second scene screen in the graphical user interface;
wherein the second scene screen comprises a second scene plot where the obstacle position is located; and
displaying a position return control; wherein the position return control is used to control the graphical user interface to display the first scene screen based on a recorded plot position of the first scene plot.

14. The method according to claim 1, wherein displaying the obstacle prompt information for the obstacle position in the expedition information control in response to the obstacle position existing on the expedition route comprises:
in response to the obstacle position existing on the expedition route and a number of the obstacle position is multiple, displaying position prompt information of a first obstacle position closest to the target team in the expedition information control.

15. The method according to claim 1, wherein after displaying the expedition information control on the first scene screen, the method further comprises:
in response to a presence of a plurality of expedition routes, displaying route information of each of the expedition routes and a selection control of each of the expedition routes in the expedition information control; wherein the selection control is used to select a corresponding expedition route to control the target team to march to the first scene plot along a selected expedition route; and
in response to the obstacle position existing on a first expedition route in the plurality of expedition routes, displaying obstacle prompt information of the obstacle position on the first expedition route in the expedition information control.

16. (canceled)

17. An electronic device, comprising a processor and a memory, wherein a graphical user interface is provided by a terminal device, the graphical user interface comprises a first scene screen of a target game scene, and the target game scene comprises a plurality of scene plots; wherein the memory stores machine-executable instructions that can be executed by the processor, and the processor executes the machine-executable instructions to implement;
in response to a trigger operation on a first scene plot in the first scene screen, determining an expedition route for a target team to march to the first scene plot;
displaying an expedition information control on the first scene screen, wherein the expedition information control is used to display expedition information of the target team marching to the first scene plot; and
in response to an obstacle position existing on the expedition route, displaying obstacle prompt information for the obstacle position in the expedition information control; wherein the obstacle prompt information comprises: position information of at least one obstacle position on the expedition route.

18. A non-transitory computer-readable storage medium, wherein the non-transitory computer-readable storage medium stores machine-executable instructions, wherein a graphical user interface is provided by a terminal device, the graphical user interface comprises a first scene screen of a target game scene, and the target game scene comprises a plurality of scene plots; wherein the machine-executable instructions, when being called and executed by a processor, prompt the processor to implement:
in response to a trigger operation on a first scene plot in the first scene screen, determining an expedition route for a target team to march to the first scene plot;
displaying an expedition information control on the first scene screen, wherein the expedition information control is used to display expedition information of the target team marching to the first scene plot; and
in response to an obstacle position existing on the expedition route, displaying obstacle prompt information for the obstacle position in the expedition information control; wherein the obstacle prompt information comprises: position information of at least one obstacle position on the expedition route.

19. The electronic device according to claim 17, wherein the processor is further configured to:
in response to the obstacle position existing on the expedition route, display at least a portion of a scene map of the target game scene in the expedition information control; wherein the at least a portion of the scene map comprises a position marker corresponding to the obstacle position.

20. The electronic device according to claim 19, wherein the processor is further configured to:
display at least a portion of the expedition route in the at least a portion of the scene map;
wherein the at least a portion of the expedition route comprises the position marker corresponding to the obstacle position and a position marker of the target team.

21. The electronic device according to claim 17, wherein the processor is further configured to:
in response to no obstacle position existing on the expedition route, display first expedition information in the expedition information control;
wherein the first expedition information comprises expedition route information, and the expedition route information comprises more than one of: time consumed for an expedition, time when the target team arrives at the first scene plot, an increased experience value, a resource spent on the expedition, a supply control, and an expedition trigger control.
